(19) United States
(12) Patent Application Publication
(10) Pub. No.: US 2002/0099717 A1
(43) Pub. Date: Jul. 25, 2002

(54) Method for report generation in an on-line transcription system

(76) Inventor: Gordon Bennett, San Diego, CA (US)

Correspondence Address: KENYON S. JENCKES, Fish & Richardson P.C., Suite 500, 4350 La Jolla Village Drive, San Diego, CA, 92122, US

(21) Appl. No.: 09/898,455

(22) Filed: Jul. 2, 2001

Related U.S. Application Data
(60) Provisional application No. 60/264,425, filed on Jan. 24, 2001.

(51) Int. Cl. G06F 7/00

(52) U.S. Cl. 707/102

(57) ABSTRACT

An on-line transcription system in which a user generates a data-entry/report template pair to be used to create reports from transcription records. The user enters transcribed text into fields of the data-entry template. The user's internet browser creates a sample report, including the user-entered content, from an HTML document stored locally on the user's computer.

### CROSS-REFERENCE TO RELATED APPLICATIONS

This application claims priority to U.S. Provisional Application Serial No. 60/264,425, filed on Jan. 24, 2001.

### BACKGROUND

Physicians and other professionals may transcribe their notes. These notes may be used to generate reports based on individual client visits. Many medical service providers, including individual physicians and hospitals, outsource their transcription work to specialized transcription services in order to reduce staffing needs.

Typically the professional dictates his or her notes into a recording device and transmits the recorded notes to a transcriber. The physician may dictate into a tape recorder and submit a physical tape cartridge to the transcription service. Alternatively, the physician may dictate into a computer recording device and transmit a digital audio file to the transcription service over an internet connection.

The recorded dictation is received by a transcriber who transcribes it into a text document. The text may be entered into the appropriate fields of a report form. Report forms may differ based on the specialty and type of service provider, and the type of visit. The report may be saved as an electronic document and returned to the physician for editing and printing. The final report may then be printed and signed by the physician.

It is desirable to provide physicians access to their report forms saved at the transcription service database remotely over an internet connection. It is also desirable to allow physicians to customize the content and style of the templates used for their report forms to suit their particular needs.

### SUMMARY

In an on-line transcription system according to an embodiment of the invention, a remote user at a client device generates a data-entry/report template pair to be used to create reports from transcription records. The user transmits the template pair to a server for storage on a database. To generate a report, the user retrieves the template pair from the server and enters transcribed text into fields of the data-entry template. The data-entry template, with user-entered content, is submitted to the server which dynamically creates a report page including hidden fields, one or more of which include user-entered content. The report page is returned to the client device, which examines the hidden fields for content. The user's browser generates a report page for display that includes fields corresponding to those hidden fields that include the user-entered content. The client-generated report page exists only in the client devices memory. If the user is satisfied with the content of the report page, the page may be returned to the server for storage on the database as an HTML document.

### BRIEF DESCRIPTION OF THE DRAWINGS

FIG. 1 is a schematic diagram of a networked computer system according to an embodiment of the invention.

FIG. 2 is a flowchart describing a template creating operation according to an embodiment of the invention.

FIG. 3 illustrates an exemplary web page for a user to enter desired template properties.

FIGS. 4A-4C include exemplary code segments for altering the style of a preview template page.

FIG. 5 illustrates an exemplary web page for a user to enter properties of components for a final report.

FIG. 6 illustrates an exemplary preview page according to an embodiment of the invention.

FIGS. 7A and 7B illustrate a flowchart describing a report generating operation according to an embodiment of the invention.

FIG. 8 illustrates an exemplary data-entry template.

FIG. 9 includes an exemplary server-side code segment for creating hidden fields in a report page.

FIG. 10 includes exemplary client-side code segments for writing the report.

FIG. 11 illustrates an exemplary report page.

### DETAILED DESCRIPTION

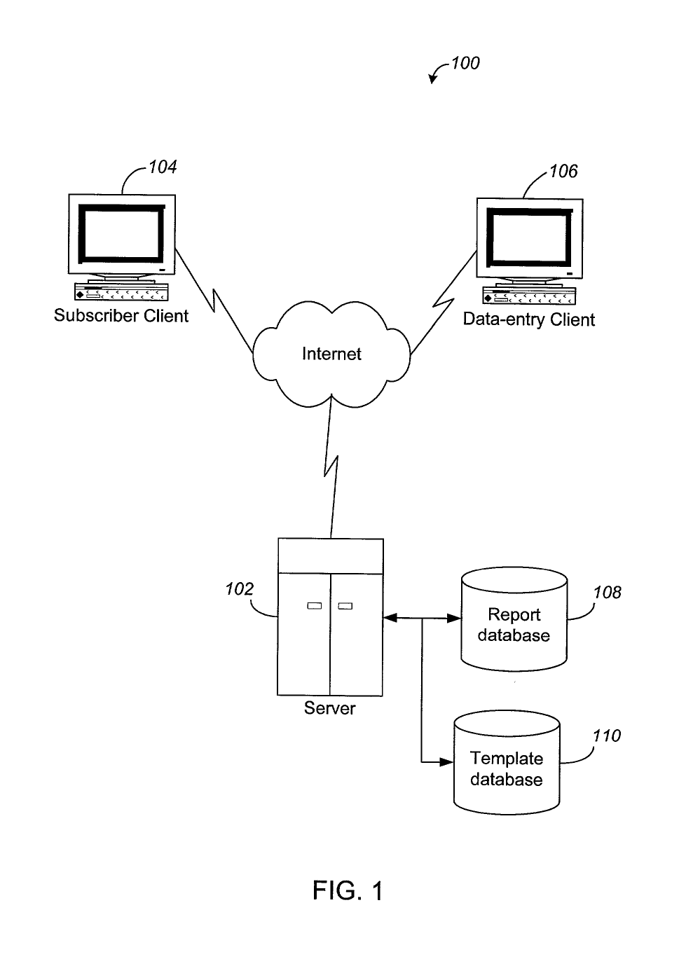

As shown in FIG. 1, a computer system 100 according to an embodiment of the invention enables a remote computer user to use an internet browser to access an application located on a server and to create and store customizable report templates with corresponding data entry templates and preview samples. The user may create the templates and preview samples by selecting a variety of attributes, such as the number of components, or sections, for the report and the caption associated therewith. The user may also select the font style and size, maximum allowable text length, and optional boilerplate text contents for each component of the report. Each template may be re-used to create many reports with the same layout, format, and components.

In one embodiment of the invention, the system 100 may be utilized by a medical transcription service and its subscribers. The template-producing application resides on a server 102. The subscribing physician may access the application from a remote client terminal 104, e.g., a personal computer (PC), to create and customize a data-entry/report template pair suitable for his or her practice, to be stored in a database at the server 102. The physician may create a report by retrieving the stored template pair from the database and entering text using speech recognition software, or, alternatively, by sending recorded dictation to a transcriber at a data-entry client terminal 106 over a network connection, e.g., an internet or Local Area Network (LAN) connection. The transcriber enters the transcribed text into the appropriate fields of the template to create and store a report in a report database 108 at the server for access by the physician.

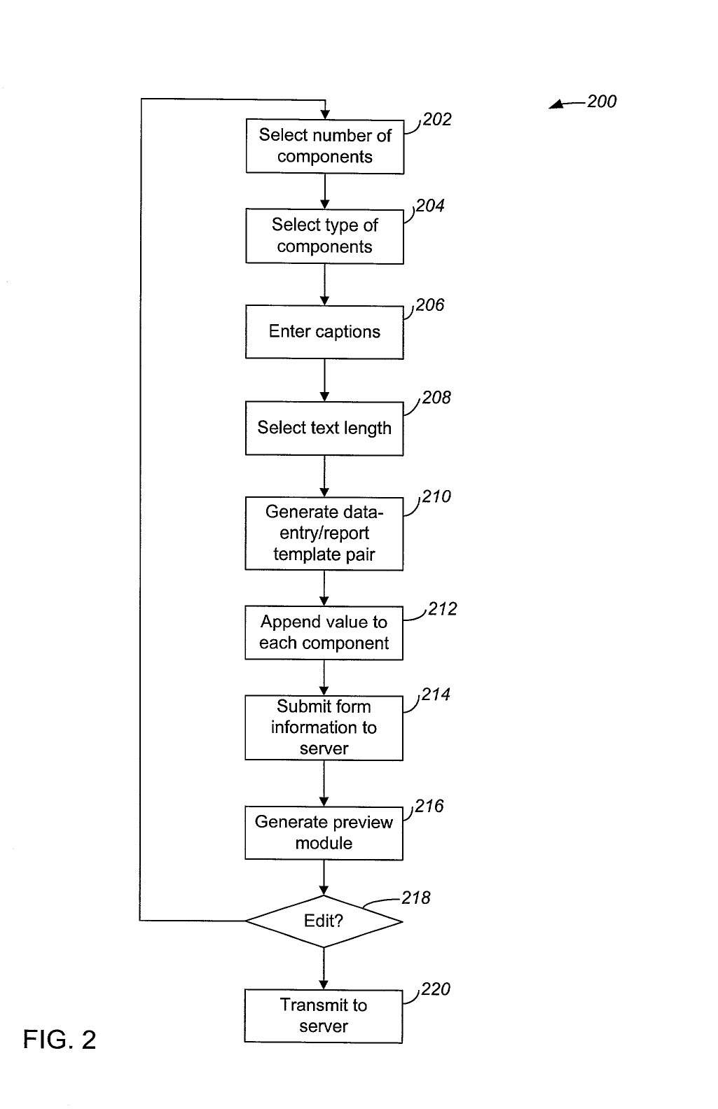

FIG. 2 is a flowchart describing an embodiment of a template creating operation 200 according to the invention. A process for creating a standard template according to one embodiment involves the dynamic creation of three matching HyperText Markup Language (HTML) “modules”, an HTML data-entry form module, an HTML document preview module, and an HTML final report module, each of which exist only in computer memory as an HTML page generated by the user's browser until the user confirms that the templates are satisfactory. At that point, the preview module is discarded, and the data-entry form and corresponding final report are saved as complete HTML documents in a database.

Although the pages and files described in connection with the present embodiment are in HTML, alternate embodiments may utilize other markup languages to create the pages and documents. These other markup languages may include, for example, Standard Generalized Markup Language (SGML), Extensible Markup Language (XML), or other markup languages that are currently available or which may become available in the future.

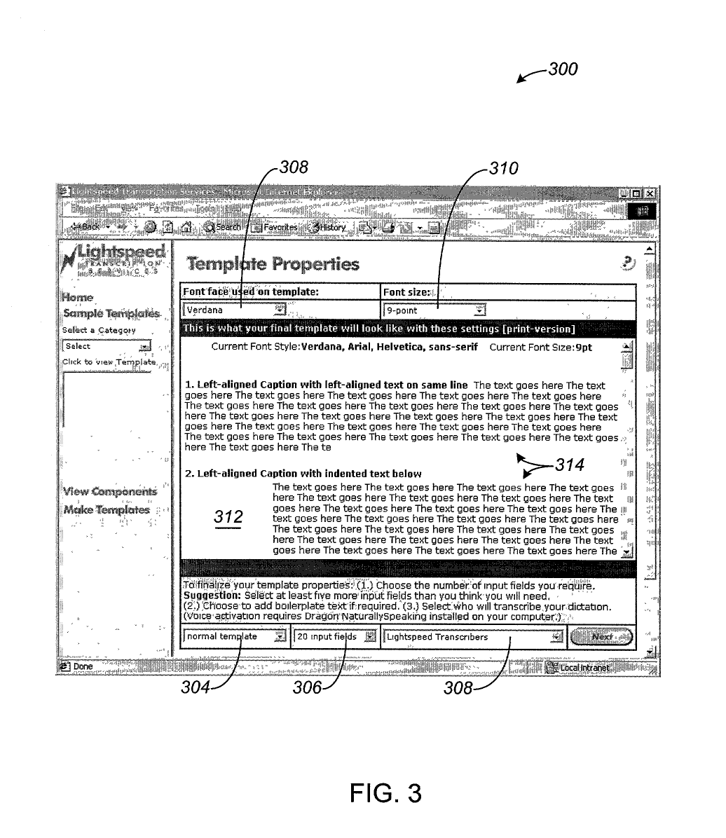

As shown in FIG. 2, the user first selects a number of components for the template that correspond to components for inclusion in the final report (block 202). The components may include, for example, a caption, input (transcribed) text, and/or boilerplate text. FIG. 3 illustrates an exemplary HTML page 300 with a field 302 for the user to enter a desired number of components. The user's internet browser generates the HTML page for display on the user's display monitor from an HTML document (file) which includes code for different elements of the displayed page. Some elements of the HTML page are dependent on the type of browser and user-entered preferences. Consequently, an HTML page generated from the same HTML document may appear different on different browsers.

The page 300 may also include a field 304 for the user to enter the type of template. The types may include a normal type in which all data is entered into the document, and a formatted type that includes boilerplate text as default text in certain selected components. The page may also include a field 306 for selecting the type of transcription, which may be either a human transcriber or a speech recognition software product, such as the Dragon NaturallySpeaking suite of speech recognition products developed by Lernout & Hauspie Speech Products U.S.A., Inc.

Fields 308, 310 may be provided for the user to select between a number of different fonts and font sizes, e.g., from a pull-down menu. Sample text 312 may be displayed in an inline frame (“iframe”) 314 that illustrates the style of the report with the selected font style and size to the user. Code may be provided in the HTML document that enables the user's computer to change the font style and/or font size in the sample text locally, i.e., without submitting the page to the server 102 to refresh its content.

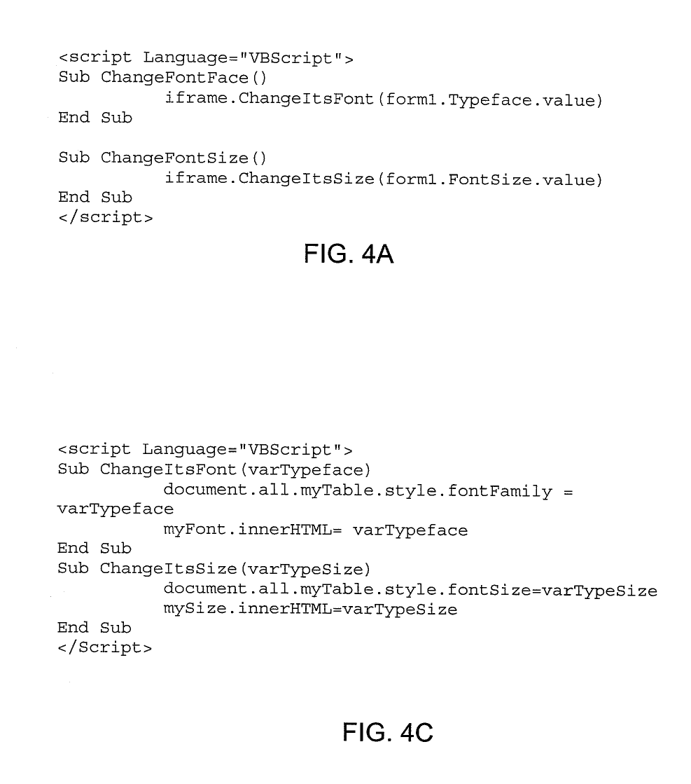

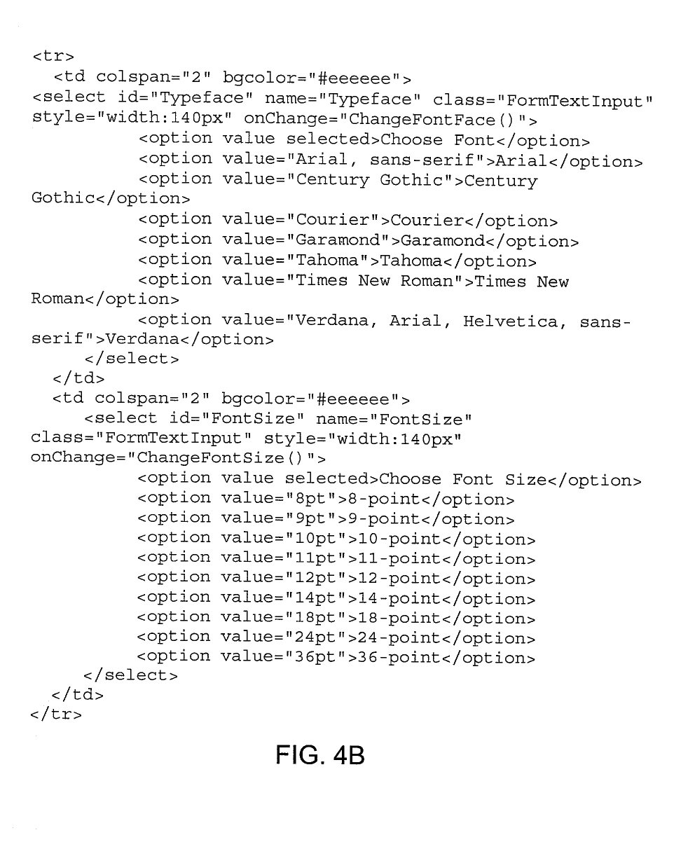

FIG. 4A includes an exemplary code segment that resides in the page 300 and refers to a sub-routine in the iframe 314 for changing the style of the sample text 312. FIG. 4B includes an exemplary code segment that resides in page 300 and allows the user to choose the font size and style. Selecting either of these attributes changes the page content to the selected attribute. FIG. 4C includes an exemplary code segment that resides in the iframe and actually makes the changes to the font size and style of the sample text 312.

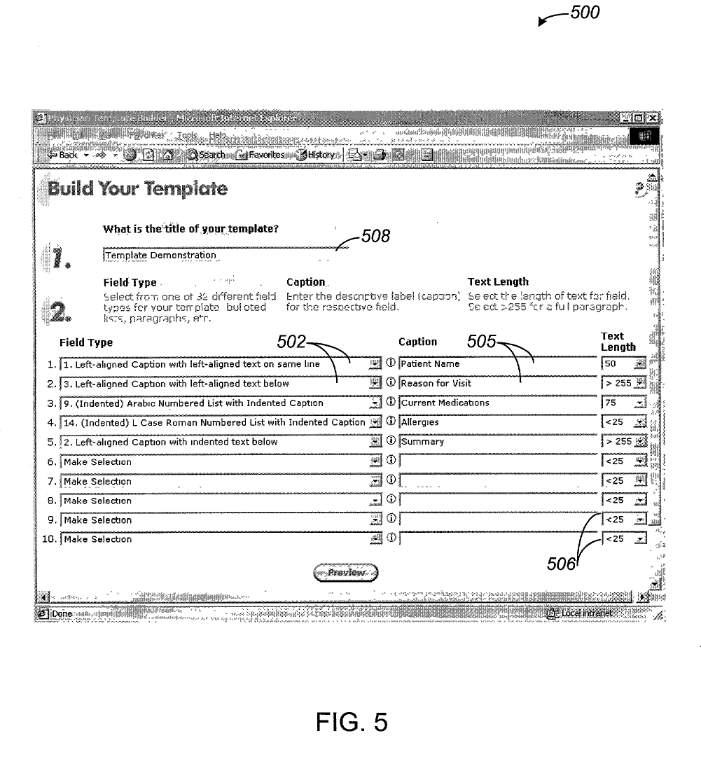

The user then selects a type (block 204) and enters a caption (block 206) for each component. FIG. 5 illustrates an exemplary HTML form page 500 with fields 502 for the user to enter a field type for each component. The field type may be selected from a pull-down menu of available types, which may include, for example, the orientation of the caption (e.g., left-aligned or indented) and orientation of text in the input field (e.g., left-aligned, indented, bulleted lists, etc.).

The user may enter a caption title for each component into the corresponding field 504, and enter a maximum allowable text length for the input field portion of the component (block 208) into corresponding field 506. The user may also enter a title for the template in field 508.

A component may include boilerplate text, which the user can enter when building the template. This boilerplate text is saved as the default text for that component in the data-entry template.

The data-entry/report template pair is generated from the report component information entered in the form pages 300, 500 (block 210). In an embodiment, an incremental numerical value is assigned to each component during the generation of the template pair (block 212). This numerical value is used to match the contents from the HTML document to corresponding locations in the report document.

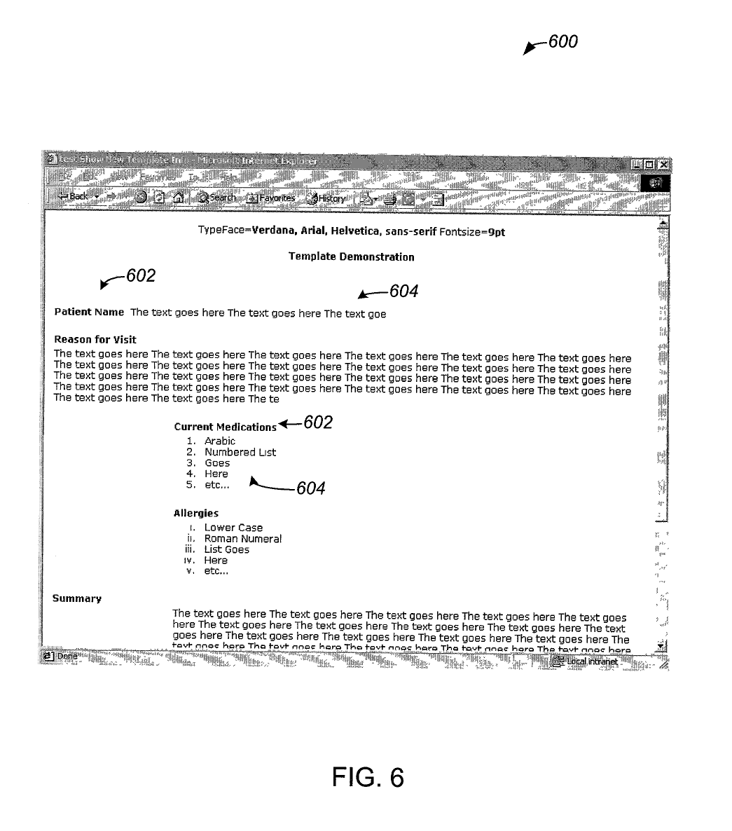

The user may preview the report by submitting the report component information to the server (block 214). As shown in FIG. 6, the preview page 600 generated by the server (block 216) shows the user-entered captions 602, together with sample text 604 to illustrate the format of the document.

After previewing the report, the user may decide to edit the report component information by returning to the form pages 300, 500 (block 218), or transmit the current data-entry/report template pair to the server for storage in a templates database 110. The data-entry/report template pair and the preview module exist only in the memory of the user's computer until the user confirms that the templates are satisfactory. At that point, the preview module is discarded, and the data-entry form and corresponding final report are saved as complete HTML documents in the templates database 110.

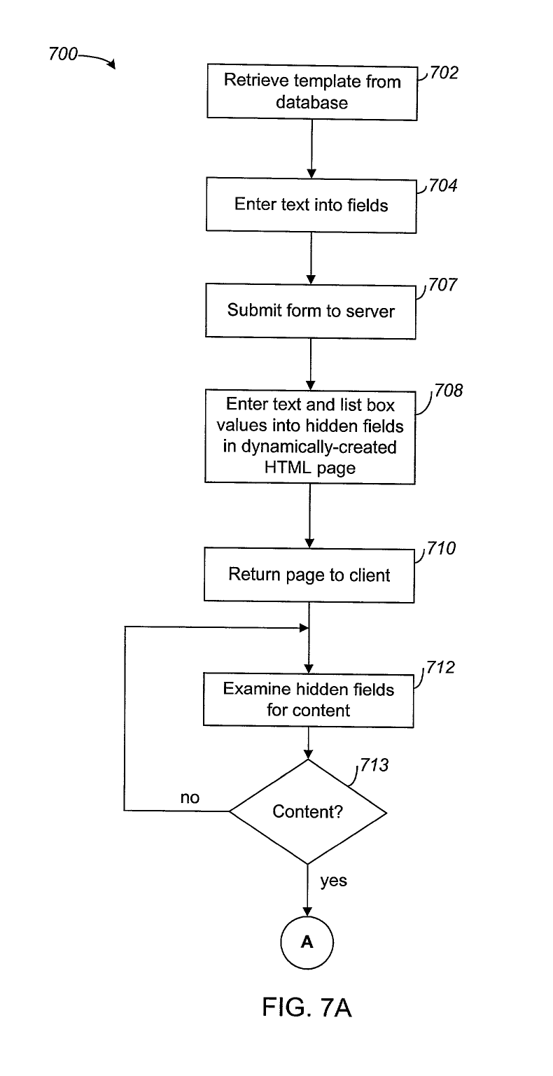

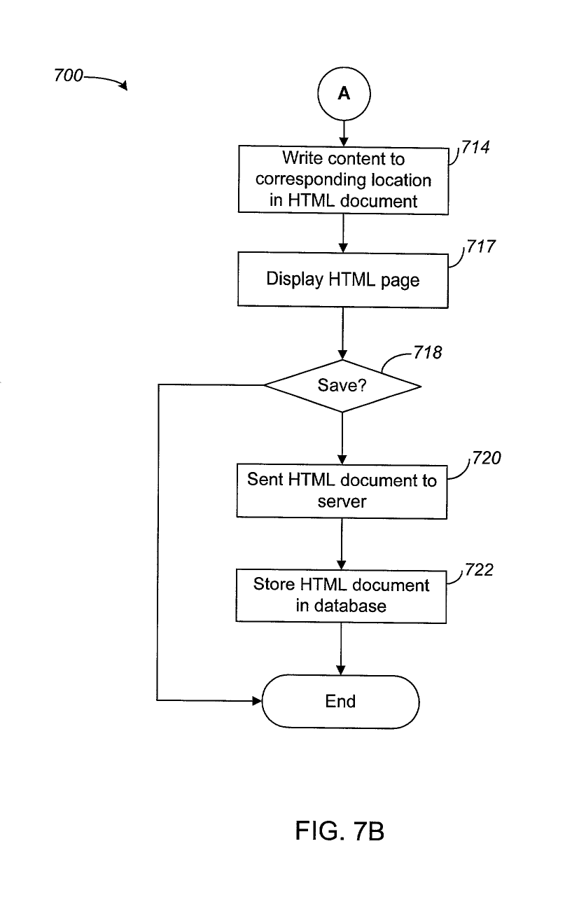

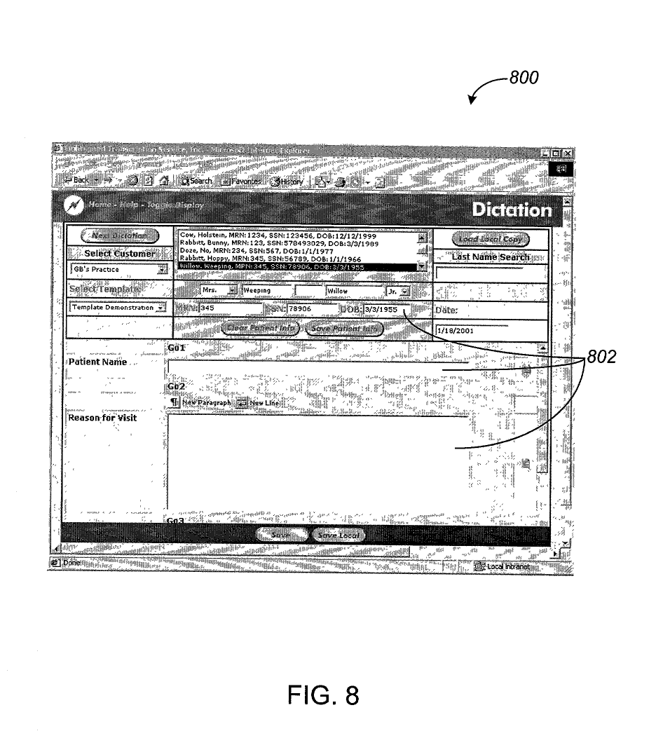

FIG. 7A is a flowchart describing an embodiment of a report generating operation 700 according to the invention. The user first selects the desired template from one or more previously generated templates in the template database 110 (block 702). FIG. 8 illustrates an exemplary HTML data-entry template 800 with a number of data entry fields 802. The user enters text for the report into the appropriate data entry field (block 704). The user may be a physician at the subscriber client device entering text with a speech recognition product or a transcriber at the data entry client device transcribing text from the physician's recorded dictation. Once the data entry is complete, the user submits the form to the server 102 (block 706), at which point the text and list-box values from the form are entered into a series of dynamically-created, hidden text fields in another HTML page (block 708).

In one embodiment, the page is generated dynamically on the server by Active Server Pages (ASP), a server-side scripting technology developed by the Microsoft Corporation. An ASP page is an HTML page that contains server-side scripts that are processed by the server before being sent to the user's browser. Server-side scripts run when the user's browser requests an asp file from the server. ASP is called by the server, which processes the requested file from top to bottom and executes any script commands. The server then formats an HTML page and sends it to the browser.

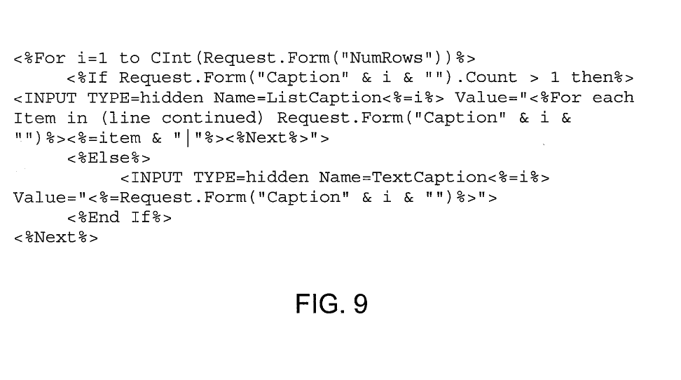

The number of hidden text fields corresponds to the number of fields on the data entry template, and each hidden field has an incremental numeric value appended to its name. FIG. 9 includes exemplary server-side code that can be used to write the hidden text fields and assign their numeric value.

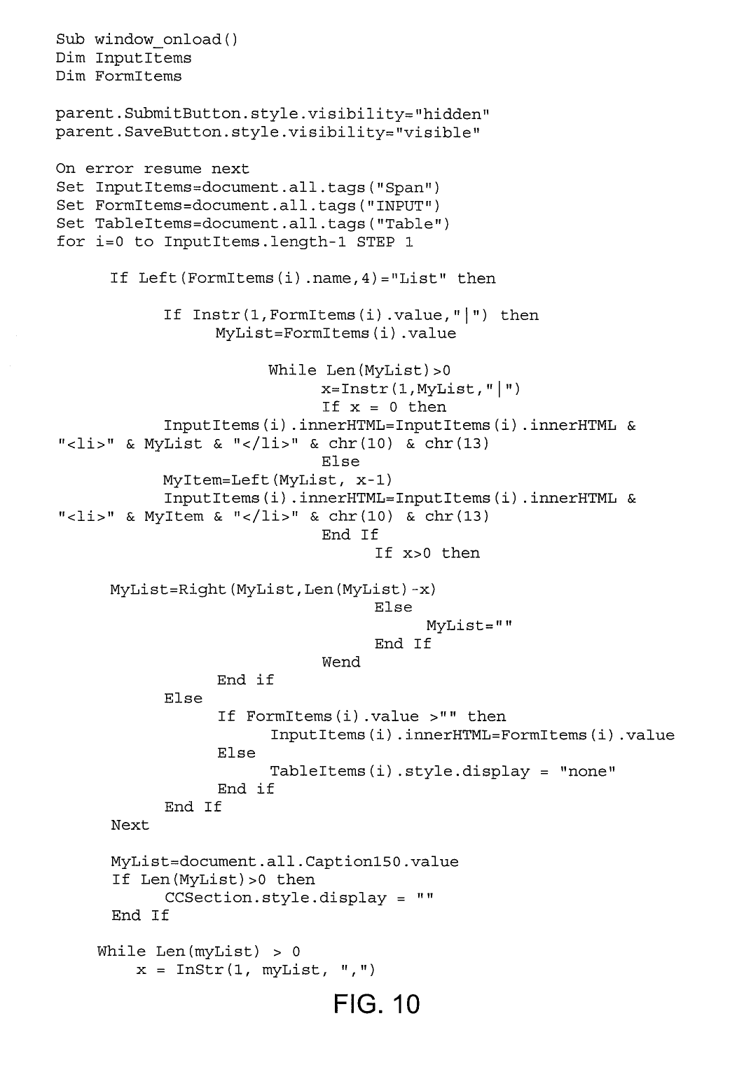

Once the new HTML page is returned to the user, a client-side code routine examines each of the hidden fields to determine if it has any content (block 713). If it does contain content, the code routine looks for a location in the HTML document having a name with an appended numeric value that matches the numeric value appended to the name of the hidden text field. As shown in FIG. 7B, the code routine then writes the content of the hidden field to the corresponding location in the HTML document (block 714). The user's browser displays the HTML page, including the fields with content, to the user. FIG. 10 includes an exemplary code segments that can be used by the client device to write the report.

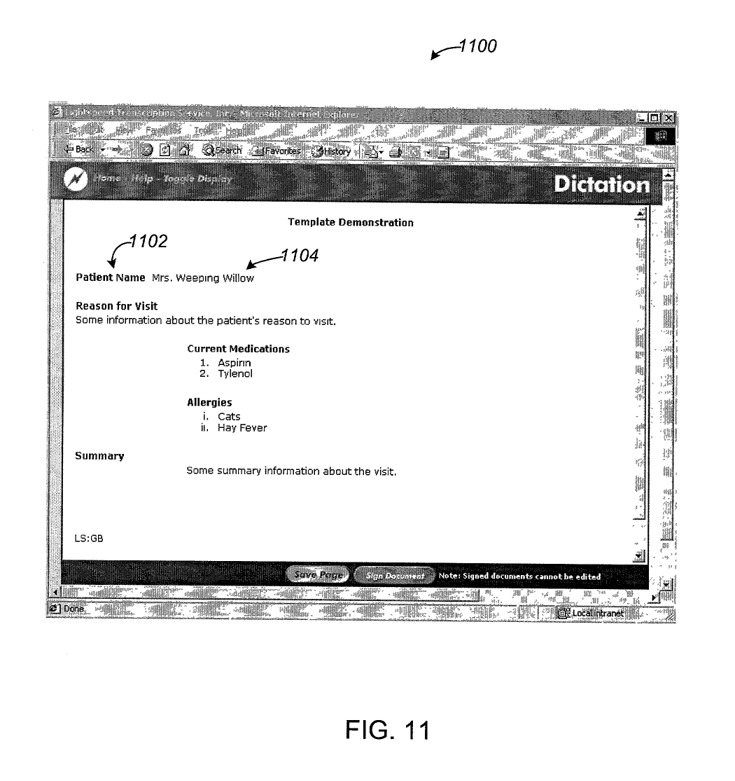

FIG. 11 illustrates an exemplary report page 1100 generated as a result of client-side processing according to the invention. The report page 1100 includes the predetermined title 1002 for each displayed component and the text 1104 entered by the user. The report page 1100 is displayed on the user's display monitor (block 716) and exists only in the memory of the client device. If the user decides not to save the report (block 718), the operation 700 ends. Otherwise, the HTML content of the report page 1100, including tags and text information, is transmitted to the report database 108 at the server 102 (block 720), for example, via a Component Object Model (COM) object.

The resulting HTML page is stored in a table field in the report database (block 722). The user may subsequently retrieve report page directly through the browser, and save the modified HTML document back to the report database 108.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

The invention has been described in terms of particular embodiments and uses. Other embodiments and uses are within the scope of the following claims. For example, the steps of the invention can be performed in a different order and still achieve desirable results. Further, the invention may be implemented for transcription services other than the medical transcription industry.

1. A method for generating a report by a client in a networked computer system, comprising:
receiving a first report page with a plurality of hidden fields from a server;
examining each hidden field for content;
generating a second report page including a plurality of fields;
in response to determining that a hidden field contains content, writing said content to a corresponding field in a second report page; and
saving said second report page for display in a local memory.

2. The method of claim 1, further comprising:
in response to determining that a hidden field contains no content, displaying the second report page without a field corresponding to that hidden field.

3. The method of claim 1, further comprising transmitting the second report page to a server for storage.

4. The method of claim 1, wherein said networked computer system comprises the Internet.

5. The method of claim 4, further comprising generating the second report page with an internet browser.

6. The method of claim 1, wherein the first and second report pages are created using one or more markup languages.

7. A method for generating a report by a client in a networked computer system comprising:
retrieving a report template from a server, said report template including a plurality of data entry fields;
entering text into one or more of said data entry fields;
submitting the report template with the entered text to the server;
receiving a first report page with a plurality of hidden fields from the server;
examining each hidden field for content;
generating a second report page including a plurality of fields;
in response to determining that a hidden field contains content, writing said content to a corresponding field in a second report page; and
saving said second report page for display in a local memory.

8. The method of claim 7, wherein the text is entered by a transcriber.

9. The method of claim 7, wherein the text is entered by a speech recognitions software product.

10. The method of claim 7, further comprising:
in response to determining that a hidden field contains no content, displaying the second report page without a corresponding field.

11. The method of claim 7, further comprising transmitting the second report page to a server for storage as a report document.

12. The method of claim 7, wherein the first and second report pages are created using one or more markup languages.

13. A system comprising:
a network communication link;
a server including a database and a processor, said processor operating to dynamically generate a first report page from a report template including user-entered content, said first report page including a plurality of hidden fields, one or more of said hidden fields including user-entered content; and
a client connected to the server over said network communication link, said client including,
a display screen,
a local memory device, and
a processor operating to receiving the first report page from the server,
examine each hidden field for content, generate a second report page including a plurality of fields, and in response to determining that a hidden field contains content, writing said content to a corresponding field in a second report page and
saving said second report page for display in the local memory.

14. The system of claim 13, wherein the client processor is further operative to display the second report page without a field corresponding to a hidden field in response to determining that said hidden field contains no content.

15. The system of claim 13, wherein the client processor is further operative to transmit the second report page to the server for storage in the database.

16. The method of claim 13, wherein the first and second report pages are created using one or more markup languages.

17. A computer program product, tangibly stored on a computer-readable medium, for generating a report by a client in a networked computer system, the product comprising instructions operable to cause a programmable processor to:
receive a first report page with a plurality of hidden fields from a server;
examine each hidden field for content;
generate a second report page including a plurality of fields;
in response to determining that a hidden field contains content, write said content to a corresponding field in a second report page; and
save said second report page for display in a local memory.

18. The article of claim 17, further comprising instructions operable to cause the processor to display the second report page without a field corresponding to a hidden field in response to determining that said hidden field contains no content.

19. A computer program product, tangibly stored on a computer-readable medium, for generating a report by a client in a networked computer system, the product comprising instructions operable to cause a programmable processor to:
retrieve a report template from a server, said report template including a plurality of data entry fields;
enter text into one or more of said data entry fields;
submit the report template with the entered text to the server;
receive a first report page with a plurality of hidden fields from the server;
examine each hidden field for content;
generate a second report page including a plurality of fields;
in response to determining that a hidden field contains content, write said content to a corresponding field in a second report page; and
save said second report page for display in a local memory.

20. The article of claim 19, further comprising instructions operable to cause the processor to display the second report page without a field corresponding to a hidden field in response to determining that said hidden field contains no content.
